(19) United States
(12) Patent Application Publication
(10) Pub. No.: US 2001/0047667 A1
(43) Pub. Date: Dec. 6, 2001

(54) Fiber-drawing method

(76) Inventors: Mickael Desalle, Maisons Laffitte (FR); Andre Dagorne, Eragny Sur Oise (FR); Jean-Pierre Bloas, Conflans Sainte Honorine (FR); Eric Lainet, Maisons Laffitte (FR); Steve Le Bris, Argenteuil (FR)

Correspondence Address: SUGHRUE, MION, ZIINN, MACPEAK & SEAS, PLLC, Suite 800, 2100 Pennsylvania Avenue, N.W., Washington, DC, 20037-3213, US

(21) Appl. No.: 09/836,336

(22) Filed: Apr. 18, 2001

(30) Foreign Application Priority Data
May 30, 2000 (FR) 00 06 934

(51) Int. Cl. C03B 37/07

(52) U.S. Cl. 65/382; 65/381; 65/377; 65/379

(57) ABSTRACT

The method consists of increasing the flowrate of argon injected into the bottom of a fiber-drawing furnace when a weld between two sections of a preform is being drawn during the operation of drawing a fiber from a preform. This prevents the weld causing an excessive increase in the diameter of the resulting fiber and/or an excessive variation in the drawing speed.

The present invention relates to a fiber-drawing method for converting a preform into an optical fiber. In particular, the invention relates to a fiber-drawing method which maintains the diameter of the optical fiber constant in spite of irregularities affecting the preform such as welds between two sections of the preform.

### BACKGROUND OF THE INVENTION

The process of fabricating an optical fiber conventionally includes fabricating a preform and then converting the preform into a fiber. The fiber-drawing operation, i.e. converting the preform into the fiber, is conventionally carried out in an installation referred to as a fiber-drawing tower, in which the preform is converted by drawing it, without contact, by melting the end of the preform in an induction furnace filled with inert gas, specifically with argon and helium. The preform is introduced into the fiber-drawing furnace at a speed referred to as the rate of descent of the preform. The resulting fiber is drawn at the outlet of the fiber-drawing tower by a capstan at a speed referred to as the drawing speed and with a tension force referred to as the drawing tension. The diameter of the fiber is measured at the outlet of the furnace in order to control the drawing speed so as to maintain the diameter of the fiber constant. The drawing speed can be more than 15 meters per second (m/s). On leaving the fiber-drawing furnace, the optical fiber is immediately coated with a primary covering, generally a resin, whose outside diameter is determined by a die through which the fiber passes. A secondary covering is sometimes applied by the same method.

To make a very long optical fibers a long preform is made by butt welding two or more preforms before carrying out the fiber-drawing operation.

The weld where two successive preforms are joined together makes the fiber-drawing operation difficult.

In particular, the weld causes breaks in the fiber and significant variations in the drawing speed and the diameter of the resulting fiber. The significant variations in the drawing speed have the disadvantage of causing variations in the diameter of the primary, and where applicable secondary, resin coverings applied on-line to the fiber at the outlet from the fiber-drawing tower. The variations in the diameter of the resulting optical fiber have the disadvantage of causing variations in the optical propagation characteristics of the fiber. In some cases the significant variations in speed can lead to irreversible destruction of the meniscus where coating is taking place, in which case the only solution is to restart the fiber-drawing operation.

The prior art solution to the problem of preventing the fiber from breaking on drawing a weld in the preform is to limit the fiber-drawing speed. That solution leads to a temporary increase in the diameter of the resulting fiber as each weld in the preform is drawn. However, the trend nowadays is to increase the diameter of the preform, and the above solution is then unsuitable. In particular, at the maximum disturbance caused by the weld, the diameter of the resulting fiber is close to the critical diameter of the die of the primary covering applicator, the effect of which is to break the fiber.

### OBJECTS AND SUMMARY OF THE INVENTION

An object of the present invention is to eliminate the disadvantages of the prior art.

To this end, the present invention proposes a method of drawing a preform including:

drawing the end of the heated preform into a fiber; and

injecting at least a first gas in the vicinity of the heated part of the preform;

and the method is characterized by varying the flowrate at which the first gas is injected in the presence of an irregularity in the preform.

The irregularity can consist of a weld between two sections of the preform.

The flowrate at which the first gas is injected is advantageously varied as a function of time in compliance with a predetermined curve.

The flowrate at which the first gas is injected is preferably varied at a rate of less than 4 liters per minute per second, more preferably at a rate of less than 1 liter per minute per second.

In a first preferred embodiment the first gas injected is argon and the step of varying the injection flowrate includes:

increasing the flowrate of argon injected in the presence of an irregularity likely to increase the diameter of the fiber, other things being equal; or

reducing the flowrate of argon injected in the presence of an irregularity likely to reduce the diameter of the fiber, other things being equal.

In this case the injection flowrate is advantageously varied by 10 to 20 liters/min or less.

In another preferred embodiment at least a second gas is injected in the vicinity of the heated part of the preform and the flowrate at which the second gas is injected is varied in the opposite direction to the variation of the flowrate at which the first gas is injected. The absolute value of the variation of the flowrate at which the second gas is injected is preferably substantially equal to the absolute value of the variation of the flowrate at which the first gas is injected. The second gas can advantageously be helium.

In a further preferred embodiment the first gas injected is helium and the step of varying the injection flowrate includes:

increasing the flowrate of helium injected in the presence of an irregularity likely to reduce the diameter of the fiber obtained, other things being equal; or

reducing the flowrate of helium injected in the presence of an irregularity likely to increase the diameter of the fiber obtained, other things being equal.

The step of varying the flowrate at which the first gas is injected can generally and advantageously have a duration in the range from 100 seconds (s) to 350 s.

In another embodiment the method includes measuring the diameter of the fiber and the flowrate at which the first gas is injected is varied depending on the measured diameter. The flowrate at which the first gas is injected can advantageously be varied if the measured diameter reaches a predefined value.

In a further embodiment, the method includes measuring the drawing speed and controlling the diameter of the fiber by action on the drawing speed and the flowrate at which the first gas is injected is varied depending on the measured drawing speed. The flowrate at which the first gas is injected can advantageously be varied if the measured drawing speed reaches a predefined value.

A further preferred embodiment of the method includes multivariable control of the drawing tension and the drawing speed by operating on the rate of descent of the preform and/or on the heating power applied to the end of the preform.

The invention is particularly advantageous because a variation in the flowrate of the inert gas injected in this way has an immediate effect on the diameter of the fiber, and consequently on the drawing speed if it is slaved to the diameter of the fiber, as is generally the case, the effect being obtained within a period of the order of one second. As a result the invention is effective in combating fast diameter variations caused by irregularities such as welds in the preform. In contrast, isolated action on the rate of descent of the preform and/or on the heating power does not effectively combat fast diameter variations, given the very slow dynamics of such systems compared to the disturbances caused by a weld and the duration of such disturbances: in fact it take around 10 to 15 minutes to achieve a new state of equilibrium.

### BRIEF DESCRIPTION OF THE DRAWINGS

Other features and advantages of the invention will become apparent on reading the following description of a preferred embodiment of the invention, which description is given by way of example and with reference to the accompanying drawings.

FIG. 1 is a graph of the diameter in microns (μm) of the fiber obtained as a function of time in seconds (s) when drawing a weld in the preform at constant drawing speed.

FIG. 2 is a graph showing the drawing speed in meters per minute (m/min) and a graph showing the diameter of the fiber obtained in microns (μm), both as a function of time in seconds (s) when drawing a weld in the preform using PID control.

FIG. 3 is a graph showing the variations in the drawing speed in meters per minute (m/min) as a function of time in seconds (s) in corresponding relationship to increases or decreases in the flowrate of injected argon using PID control.

FIG. 4 shows results obtained using a preferred embodiment of the invention.

### MORE DETAILED DESCRIPTION

Fiber-drawing tests were carried out on long preforms obtained by butt welding several preforms. A standard welding method was used. The tests were carried out on long preforms each consisting of five butt-welded preforms (sections) each having a length of 75 millimeters (mm). Each of the resulting preforms therefore included four welds. The diameter of the preform was in the range 81 mm to 85 mm. The fiber-drawing tests were carried out with a fiber-drawing tower including a primary covering applicator having a 220 μm diameter die.

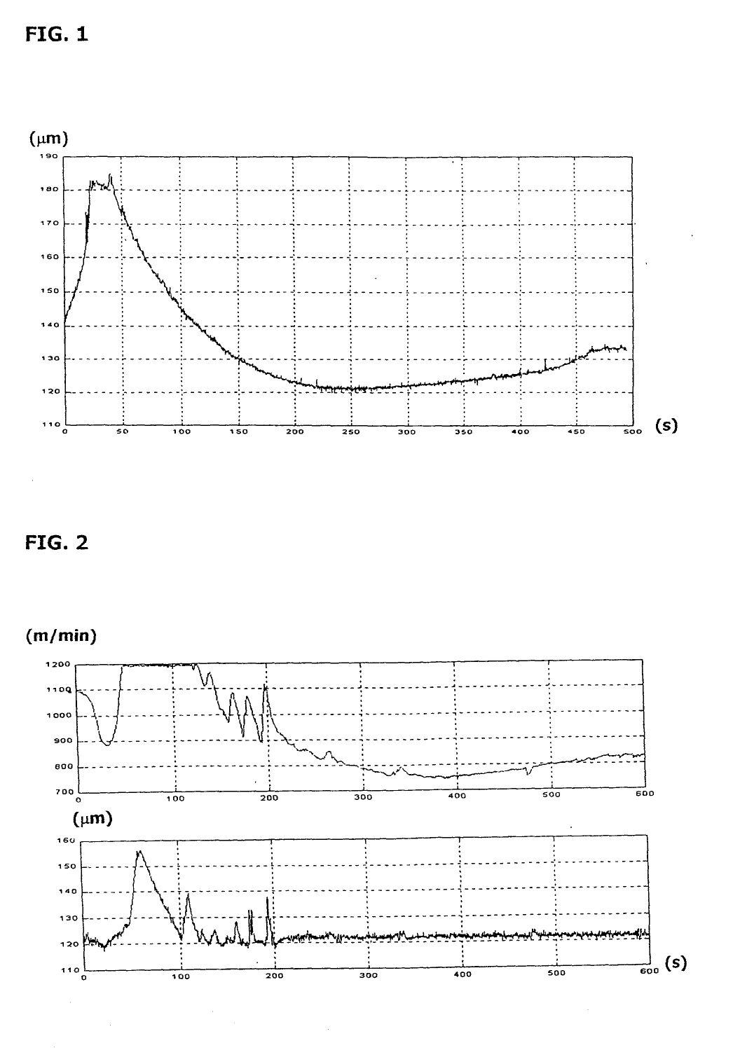

A first series of fiber-drawing tests was carried out with a constant drawing speed of 990 m/min. As a result, an optical fiber was obtained having a constant diameter of 132 μm. However, while drawing each weld, the diameter of the resulting fiber increased progressively to 185 μm and then reverted progressively to 132 μm, the duration of the corresponding disturbance being about 15 minutes. FIG. 1 is a graph showing the diameter of the fiber obtained as a function of time while drawing a weld. These variations in the fiber diameter were too great and lead to the disadvantages already cited.

A second series of fiber-drawing tests was carried out with PID (proportional, integral, derivative) control without saturation applied to the drawing speed to maintain the diameter of the resulting fiber as constant as possible. As a result, a fiber was obtained having a constant diameter of 125 μm. The variations in the diameter of the resulting fiber while drawing each weld were smaller, the maximum diameter being 155 μm. The duration of the corresponding disturbance was also about 15 minutes. Between the welds, the drawing speed was constant at 990 m/min. However, while drawing each weld, the drawing speed varied significantly because of the PID control, and the range of drawing speed variation reached 450 m/min, with a maximum speed of 1200 m/min, which was the maximum speed of the capstan. FIG. 2 is a graph showing the drawing speed and a graph showing the diameter of the fiber obtained, both as a function of time, while drawing a weld. Variations in the diameter of the primary and secondary resin coverings of the fiber due to variations in the drawing speed were also observed.

The method used in the second series of tests limited variations in the diameter of the resulting fiber but the variations in the drawing speed were too great to be acceptable.

What is more, both series of tests were interrupted several times by the fiber breaking.

The present invention is based on the observation that, during the fiber-drawing operation, the quantity of inert gas (e.g. argon) injected into the bottom of the induction furnace of the fiber-drawing tower has a significant impact on the diameter of the resulting optical fiber, other things being equal.

By the “bottom” of the furnace is meant the area of the furnace in which the heated preform is drawn.

Tests showed that, at constant drawing speed, increasing the flowrate of injected argon reduces the diameter of the resulting fiber and that reducing the flowrate of injected argon increases the diameter of the resulting fiber.

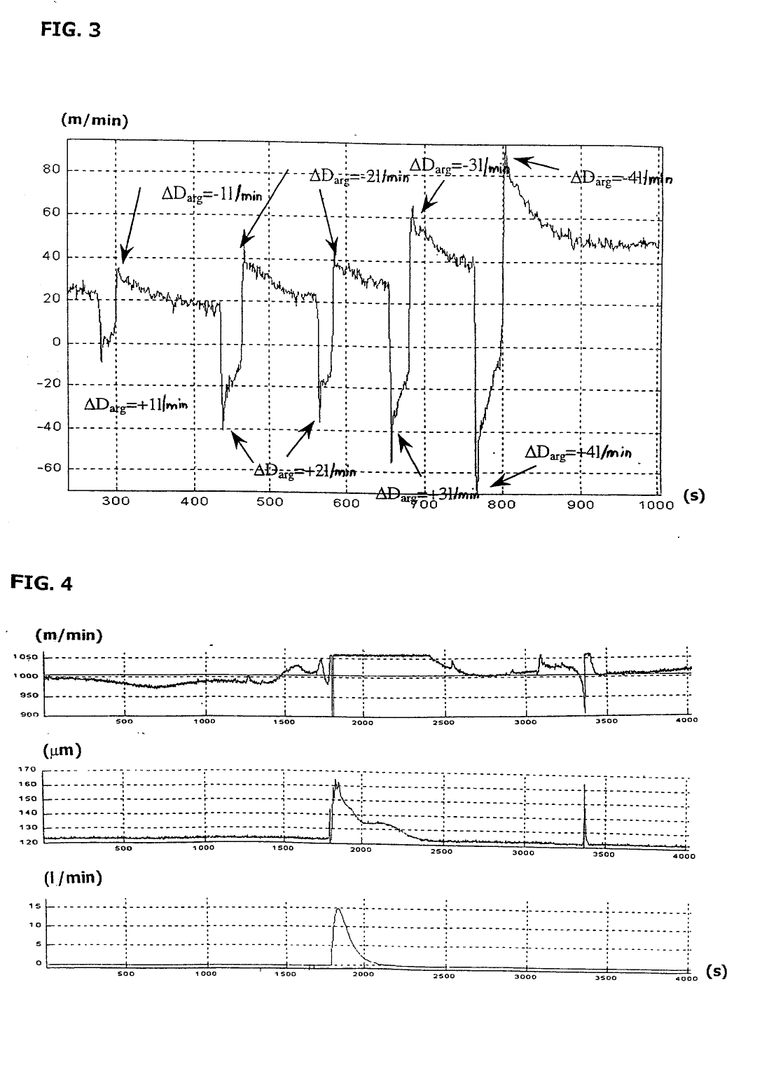

Fiber-drawing tests were also carried out on preforms without welds or other irregularities, under the same conditions as the tests of the second series, and varying the flowrate of argon injected into the bottom of the furnace. The nominal drawing speed was 1000 m/min and the nominal flowrate of injected argon was 10 liters per minute (l/min). FIG. 3 shows the variations in the drawing speed (in meters per minute) relative to the nominal drawing speed as a function of time (in seconds), in corresponding relationship to the increased or decreased flowrate of injected argon. The values of ΔD_{arg} in the figure correspond to variations in the flowrate of argon relative to the nominal flowrate. Thus a negative variation of the drawing speed of up to 80 m/min (the speed falling to 920 m/min in this case) was obtained, for example, if the flowrate of injected argon was increased by 4 l/min (to 14 l/min). FIG. 3 shows that the drawing speed increases as the flowrate of injected argon decreases and that the drawing speed decreases as the flowrate of argon increases. The speed variations are obviously explained by the use of PID control, which varies the drawing speed to compensate variations in the diameter of the fiber due to variations in the flowrate of injected argon.

The tests also showed that varying the flowrate of argon had an immediate impact on the diameter of the fiber. In the tests illustrated by FIG. 3, it was observed that drawing speed variations followed increases or decreases in the flowrate of injected argon with a reaction time of the order of one second or even less.

Similar tests carried out with helium showed that varying the flowrate of helium injected into the bottom of the furnace also influenced the diameter of the resulting fiber, but much less so than argon. At constant drawing speed, varying the flowrate of helium injected at the bottom of the furnace caused the diameter of the resulting fiber to vary in the same direction, which was the opposite of the effect obtained with argon.

During the fiber-drawing operation, the invention limits variations in the diameter of the resulting optical fiber and/or variations in the fiber-drawing parameters controlled as a function of the diameter of the resulting optical fiber (such as the drawing speed or the rate of descent of the preform) which tend to generate irregularities affecting the preform. It does so by varying the flowrate of inert gas (e.g. argon) injected into the bottom of the fiber-drawing furnace as the irregularities pass through it.

The expression “irregularity of the preform” means any irregularity of the preform whose effect, during fiber drawing under conditions that are constant with regard to time, is to causes the diameter of the resulting fiber to vary. This typically refers to welds between sections making up a long preform. It could also refer to variations in the outside diameter of the preform.

A preferred embodiment of the invention is described next with a preform including welds and of the type used for the above tests. The fiber-drawing tower was of a type known in the art and corresponded to that used for the above tests.

Outside the areas incorporating welds, the preform was drawn under the following nominal operating conditions:

drawing speed: 1000 m/min;

drawing tension: 85 grams (g);

preform rate of descent: 2 mm/min;

fiber-drawing furnace heating power: 18 kW;

flowrate of argon injected into bottom of furnace: 10 l/min;

flowrate of helium injected into bottom of furnace: 10 l/min; and

diameter of bare fiber before application of resin covering at outlet from fiber-drawing tower: 125 μm.

More generally, it is advantageous for the rate of descent of the preform under nominal operating conditions to be in the range 1 mm/min to 3 mm/min, the heating power of the furnace to be in the range 15 kW to 25 kW, and the flowrate of argon and the flowrate of helium injected into the bottom of the furnace each be in the range 5 l/min to 20 l/min.

As previously described, drawing a weld in the preform tends to cause a corresponding increase in the diameter of the optical fiber and/or a variation in the drawing speed controlled relative to the diameter of the resulting fiber. In order to ensure that fiber drawing proceeds correctly and the primary covering is applied correctly, and to produce an optical fiber having satisfactory optical characteristics, it is desirable to limit the diameter of the resulting optical fiber to 180 μm maximum and the drawing speed to 1050 m/min.

The diameter of the resulting fiber is checked in the conventional way by a first stage of control that varies the drawing speed of the capstan to maintain the diameter of the fiber constant. The first stage of control preferably uses an internal model. The diameter of the fiber at the outlet from the fiber-drawing tower is measured in a manner that is known in the art. The skilled person can determine the internal control model by trial and error, in a manner that is known in the art. PID control or any other suitable form of control can be substituted for internal model control. This first stage of control is not necessary for the functioning of the invention itself.

To eliminate variations in the diameter of the fiber while drawing welds in the preform, the flowrate of argon injected at the bottom of the furnace is increased while the weld is passing through the furnace. It would be possible to reduce the quantity of helium injected at the bottom of the furnace instead, with the same aim in view. However, varying the argon flowrate is better because it has a greater impact on the diameter of the fiber than does varying the helium flowrate. It is also possible to vary both the argon flowrate and the helium flowrate.

An additional flowmeter with a maximum capacity of 30 l/min is used to increase the nominal argon flowrate while drawing welds.

The additional flowmeter increases the flowrate of argon injected into the bottom of the furnace at the moment a weld in the preform begins to be drawn. It is possible to estimate the time this occurs as a function of the time elapsed since the start of drawing, for example, or since drawing a preceding weld. It is also possible to determine when it occurs by detecting when the diameter of the resulting fiber increases to a particular threshold value. It is further possible to determine when it occurs by detecting when the drawing speed increases beyond a threshold value which corresponds to intervention by the first stage of control to combat the increase in diameter caused by a weld. The above methods of determining when the event of interest occurs can be implemented by an appropriate electronic system that will be evident to the skilled person. It is advantageous to combine cumulatively two or even all three of the aforementioned methods to determine when drawing a weld in the preform begins. In this example, the drawing speed reaching 1050 m/min is detected and the fiber diameter reaching 130 μm is detected.

When it is detected that drawing a weld has begun, a command is sent to the additional flowmeter to increase the flowrate of argon injected at the bottom of the furnace. The magnitude of the additional flowrate of argon is determined to maintain the diameter of the fiber at its nominal diameter or at least below a predetermined value slightly greater than the nominal diameter. The magnitude of the additional flowrate of argon can be determined by trial and error and in accordance with the characteristics of the preform and the nominal fiber-drawing conditions adopted. Generally speaking, it is advantageous to inject an additional flowrate of argon in the range 10 l/min to 20 l/min. In this example the maximum additional flowrate of argon is 15 l/min. It is advantageous to increase the flowrate progressively so as not to cause sudden variations in pressure in the fiber-drawing furnace, which could interfere with the fiber-drawing operation. The flowrate variation is preferably less than 4 liters per minute per second, in which case the maximum additional flowrate of 15 liters per minute is applied progressively over a period of more than four seconds. The flowrate variation is advantageously less than 1 liter per minute per second.

When drawing a weld in the preform has finished, the injected argon flowrate must be reduced to its nominal value. It is advantageously reduced progressively, in the same way as it was increased. It is advantageous to reduce the argon flowrate as soon as a reduction in the diameter of the resulting fiber is detected.

If different welds in any particular preform and welds in different preforms each generate substantially the same disturbances during fiber drawing, the curve of variation of the additional flowrate of argon to be injected as a function of time can be predetermined, for example by trial and error, the same curve then governing the additional flowrate of argon to be injected while each of the welds is being drawn. This kind of method can be implemented by applying a set point step to a second order digital filter whose output signal is fed to the input of a differentiator when the interference due to a weld begins. A signal is obtained at the output having a front rising progressively from zero to a maximum value and then falling progressively, but more slowly, to zero. Applying this output signal to the control input of the additional flowmeter causes the argon injection flowrate to conform to a curve of identical profile. In this example, the maximum additional flowrate of 15 l/min is reached 40 seconds after starting to increase the flowrate. The additional flowrate returns to zero about 200 seconds after starting to increase the flowrate. Generally speaking, the injected gas flowrate is advantageously varied for a period in the range from 100 s to 350 s. FIG. 4 shows a curve of the variation in the additional injected argon flowrate.

As an alternative, the argon flowrate can be varied in accordance with the diameter of the resulting optical fiber.

It is advantageous to apply a second stage of control, preferably of the multivariable type and controlling the drawing speed and the drawing tension by operating on the rate of descent of the preform and/or on the heating power of the fiber-drawing furnace. The second stage of control is preferably of the linear quadratic Gaussian (LQG) type. In a manner that is known in the art, the skilled person preferably defines the second level of control so that it offers high performance in terms of being able to prevent the drawing speed exceeding a given maximum speed while drawing the preform between welds. The maximum speed is the estimated speed of a weld during drawing, which is 1050 m/min in this example. The second stage of control can also limit variations in the drawing speed while drawing welds and as caused by the first stage of control.

Furthermore, it is advantageous to apply saturation to the drawing speed so that it does not exceed the aforementioned maximum speed at the disturbances.

FIG. 4 shows the results obtained for this example. It can be seen that the diameter of the optical fiber reaches a maximum value of 165 μm while drawing a weld and that the drawing speed is limited to 1050 m/min, which is a highly satisfactory result.

In a preferred embodiment, the increase in the argon flowrate is compensated by a corresponding reduction in the helium flowrate. The effect of this is to combine the action of the two gases to maintain the diameter of the fiber close to its nominal value. However, as a result of this the pressure of the gases in the bottom of the furnace also remains substantially constant.

Of course, the present invention is not limited to the examples and embodiments described and shown and lends itself to many variants that will suggest themselves to the skilled person.

1. A method of drawing a preform, the method including:
drawing the end of the heated preform into a fiber; and
injecting at least a first gas in the vicinity of the heated part of the preform;
and being characterized by varying the flowrate at which the first gas is injected in the presence of an irregularity in the preform.

2. The method of claim 1, wherein the irregularity consists of a weld between two sections of the preform.

3. The method of claim 1, wherein the flowrate at which the first gas is injected is varied as a function of time in accordance with a predetermined curve.

4. The method of claim 1, wherein the flowrate at which the first gas is injected is varied at a rate of less than 4 liters per minute per second, preferably at a rate of less than 1 liter per minute per second.

5. The method of claim 1, wherein the first gas injected is argon and wherein the step of varying the injection flowrate includes:
increasing the flowrate of argon injected in the presence of an irregularity likely to increase the diameter of the fiber, other things being equal; or
reducing the flowrate of argon injected in the presence of an irregularity likely to reduce the diameter of the fiber, other things being equal.

6. The method of claim 5, wherein the injection flowrate is varied by 10 l/min to 20 l/min or less.

7. The method of claim 1, wherein at least a second gas is injected in the vicinity of the heated part of the preform and the flowrate at which the second gas is injected is varied in the opposite direction to the variation of the flowrate at which the first gas is injected.

8. The method of claim 7, wherein the absolute value of the variation in the flowrate at which the second gas is injected is substantially equal to the absolute value of the variation of the flowrate at which the first gas is injected.

9. The method of claim 7, wherein the second gas is helium.

10. The method of claim 1, wherein the first gas injected is helium and wherein the step of varying the injection flowrate includes:
increasing the flowrate of helium injected in the presence of an irregularity likely to reduce the diameter of the fiber obtained, other things being equal; or
reducing the flowrate of helium injected in the presence of an irregularity likely to increase the diameter of the fiber obtained, other things being equal.

11. The method of claim 1, wherein the step of varying the flowrate at which the first gas is injected has a duration in the range from 100 s to 350 s.

12. The method of claim 1, including measuring the diameter of the fiber and wherein the flowrate at which the first gas is injected is varied in accordance with the measured diameter.

13. The method of claim 12, wherein the flowrate at which the first gas is injected is varied if the measured diameter reaches a predefined value.

14. The method of claim 1, including measuring the drawing speed and controlling the diameter of the fiber by action on the drawing speed and wherein the flowrate at which the first gas is injected is varied in accordance with the measured drawing speed.

15. The method of claim 14, wherein the flowrate at which the first gas is injected is varied if the measured drawing speed reaches a predefined value.

16. The method of claim 1, characterized by multivariable control of the drawing tension and the drawing speed by operating on the rate of descent of the preform and/or on the heating power applied to the end of the preform.
